(19) United States
(12) Patent Application Publication
(10) Pub. No.: US 2025/0348280 A1
(43) Pub. Date: Nov. 13, 2025

(54) PSEUDO RANDOM NUMBER GENERATOR, PSEUDO RANDOM NUMBER GENERATION METHOD, AND COMPUTER-READABLE STORAGE MEDIUM

(71) Applicant: Fujitsu Limited, Kawasaki-shi (JP)

(72) Inventor: Anh Hoang Ngoc Nguyen, Toronto (CA)

(73) Assignee: Fujitsu Limited, Kawasaki-shi (JP)

(21) Appl. No.: 19/197,234

(22) Filed: May 2, 2025

(30) Foreign Application Priority Data
May 8, 2024 (JP) 2024-075646

(51) Int. Cl. G06F 7/58; G06F 7/499

(52) U.S. Cl. CPC G06F 7/582; G06F 7/49915

(57) ABSTRACT

A pseudo random number generator includes a first generator configured to generate a random first bit sequence having a bit length with floating-point representation, and a second generator configured to generate a second bit sequence having the bit length, using a predetermined sign bit, a bit sequence of a predetermined exponent part, and a bit sequence of a mantissa part included in the first bit sequence.

### CROSS-REFERENCE TO RELATED APPLICATIONS

This application is based upon and claims the benefit of priority of the prior Japanese Patent Application No. 2024-075646, filed on May 8, 2024, the entire contents of which are incorporated herein by reference.

### FIELD

The embodiments discussed herein are related to pseudo random number generation techniques, including pseudo random number generators, pseudo random number generation methods, and computer-readable storage media.

### BACKGROUND

A linear feedback shift register (LFSR) is a shift register that receives, as input bits, an exclusive OR (XOR) of a part of a bit sequence constituting a value of the shift register. The LFSR may be used for pseudo random number generation.

As a method of generating pseudo random numbers, there is a known random number generation method of generating arbitrary M-sequence random numbers with K bits or less (refer to Japanese Laid-Open Patent Publication No. 2005-352904, for example).

The LFSR generates the pseudo random numbers by performing an operation called Xorshift. The Xorshift is an operation combining an exclusive OR and a bit shift, and is used to generate the pseudo random numbers with fixed-point representation.

However, recent artificial intelligence (AI) applications or the like often use random numbers with floating-point representation.

Further, in a parallel computing system including a plurality of processing elements (PEs), a reconfigurable architecture, such as a coarse grained reconfigurable array (CGRA), a systolic array, or the like may be used. In the reconfigurable architecture, a reconfigurable matrix is formed by interconnecting the PEs by data paths. In such a parallel computing system, it is desirable that a random number with floating-point representation is supplied to each row or column of the reconfigurable matrix.

### SUMMARY

Accordingly, it is an object in one aspect of the embodiments to efficiently generate pseudo random numbers with floating-point representation.

According to one aspect of the embodiments, a pseudo random number generator includes a first generator configured to generate a random first bit sequence having a bit length with floating-point representation; and a second generator configured to generate a second bit sequence having the bit length, using a predetermined sign bit, a bit sequence of a predetermined exponent part, and a bit sequence of a mantissa part included in the first bit sequence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a functional configuration of a pseudo random number generator according to one embodiment;

FIG. 2 is a flow chart illustrating an example of a random number generation process;

FIG. 3 is a block diagram illustrating an example of a hardware configuration of a first pseudo random number generator;

FIG. 4 is a diagram illustrating an example of a hardware configuration of a first LFSR;

FIG. 5 is a diagram illustrating an example of a hardware configuration of a second LFSR;

FIG. 6 is a diagram illustrating an example of a hardware quantity;

FIG. 7 is a diagram illustrating an example of a distribution of pseudo random numbers;

FIG. 8 is a block diagram illustrating an example of a hardware configuration of a second pseudo random number generator; and

FIG. 9 is a block diagram illustrating an example of a hardware configuration of an information processing apparatus.

### DESCRIPTION OF EMBODIMENTS

Preferred embodiments of the present invention will be described with reference to the accompanying drawings.

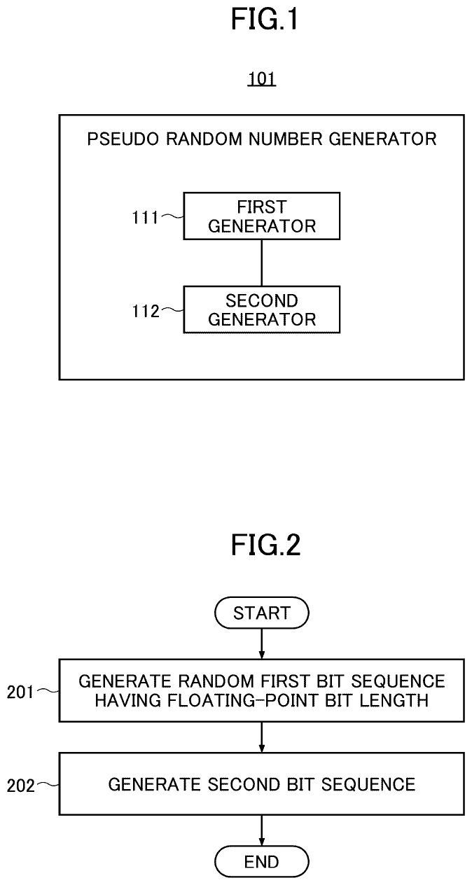

FIG. 1 illustrates an example of a functional configuration of a pseudo random number generator according to one embodiment. A pseudo random number generator 101 illustrated in FIG. 1 includes a first generator 111 and a second generator 112.

FIG. 2 is a flow chart illustrating an example of a random number generation process performed by the pseudo random number generator 101 illustrated in FIG. 1. First, in step 201, the first generator 111 generates a random first bit sequence having a bit length with floating-point representation (or a bit length of a floating-point number). Next, in step 202, the second generator 112 generates a second bit sequence having the bit length of the first bit sequence, using a predetermined sign bit, a bit sequence of a predetermined exponent part (or predetermined exponent bit sequence), and a bit sequence of a mantissa part included in the first bit sequence (or mantissa bit sequence).

The pseudo random number generator 101 illustrated in FIG. 1 can efficiently generate pseudo random numbers with floating-point representation.

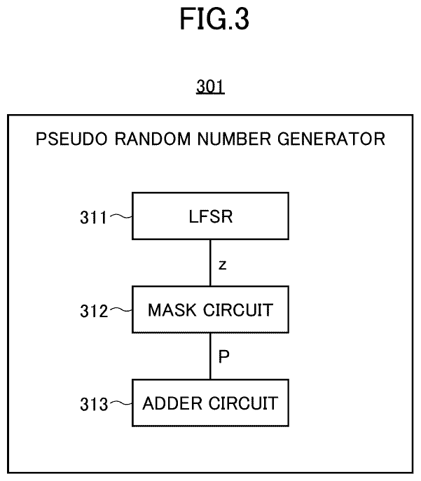

FIG. 3 illustrates an example of a hardware configuration of a first pseudo random number generator. A pseudo random number generator 301 illustrated in FIG. 3 corresponds to the pseudo random number generator 101 illustrated in FIG. 1, and generates pseudo random numbers with floating-point representation in an open interval (1.0; 2.0). The pseudo random number generator 301 includes a LFSR 311, a mask circuit 312, and an adder circuit 313. The LFSR 311, the mask circuit 312, and the adder circuit 313 are hardware circuits or components.

The LFSR 311 corresponds to the first generator 111 illustrated in FIG. 1, and the mask circuit 312 and the adder circuit 313 correspond to the second generator 112 illustrated in FIG. 1.

The LFSR 311 stores a bit sequence having a bit length with floating-point representation, and updates the bit sequence using Xorshift at a predetermined clock cycle. Further, the LFSR 311 outputs the updated bit sequence z to the mask circuit 312. An initial value (or a seed value) of the bit sequence is set by a user or an external device.

By using the LFSR 311, a different bit sequence can be generated for each clock cycle. The updated bit sequence z is an example of the random first bit sequence.

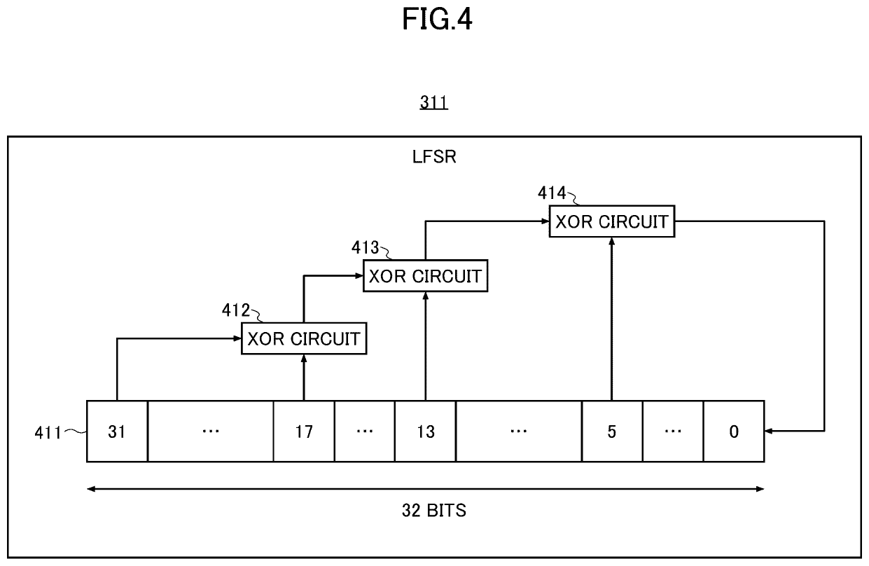

FIG. 4 illustrates an example of a hardware configuration of the first LFSR 311. The LFSR 311 illustrated in FIG. 4 includes a shift register 411, an XOR circuit 412, an XOR circuit 413, and an XOR circuit 414. The shift register 411, the XOR circuit 412, the XOR circuit 413, and the XOR circuit 414 are hardware circuits or components.

The shift register 411 stores a bit sequence having a bit length with single-precision floating-point representation (or a single-precision floating-point number) prescribed by the Institute of Electrical and Electronics Engineers (IEEE) 754 standard. The bit length with the single-precision floating-point representation is 32 bits. Among bit 0 to bit 31, bit 0 to bit 22 represent the mantissa part, bit 23 to bit 30 represent the exponent part, and bit 31 represents the sign.

The XOR circuit 412 outputs an exclusive OR of a bit value of the bit 17 and a bit value of the bit 31 of the shift register 411 to the XOR circuit 413. The XOR circuit 413 outputs an exclusive OR of ae bit value of the bit 13 of the shift register 411 and the output from the XOR circuit 412 to the XOR circuit 414.

The XOR circuit 414 outputs an exclusive OR of a bit value of the bit 5 of the shift register 411 and the output from the XOR circuit 413 to the bit 0 of the shift register 411. Accordingly, a bit value of a bit i (i=0 to 30) before the update is shifted to the bit i+1, and the bit 0 to the bit 31 after the shift are output as the bit sequence z.

The Xorshift by the LFSR 311 illustrated in FIG. 4 can be described by the following formula (1), for example.

z=z\hat{ }z_13\hat{ }z_17\hat{ }z_5 (1)

In the formula (1), “z_i” represents the bit value of the bit i of the shift register 411, and “\hat{ }” represents an exclusive OR.

The mask circuit 312 outputs a logical product P of the bit sequence z output from the LFSR 311 and a mask bit sequence M to the adder circuit 313. The value of each bit of the sign and the exponent part of the mask bit sequence M is a logical value 0, and the value of each bit of the mantissa part is a logical value 1. The mask circuit 312 generates the logical product P to modify the value of each bit of the sign and the exponent part included in the bit sequence z to the logical value 0. The logical product P is an example of a third bit sequence, and the mask circuit 312 is an example of a modification circuit or unit.

In the case of the single-precision floating-point number, the mask bit sequence M can be expressed by the following formula (2).

M=0000 0000 0111 1111 1111 1111 1111 1111 (2)

As an example, it is possible to assume a bit sequence z expressed by the following formula (3).

z=0100 1000 1111 0000 1110 1110 0000 0000 (3)

In this case, the logical product P can be obtained using the following formula (4).

P=Z & M=0000 0000 0111 0000 1110 1110 0000 0000 (4)

The adder circuit 313 adds a predetermined bit sequence L to the logical product P in the floating-point representation, and outputs an addition result as a pseudo random number R. The bit sequence L represents an endpoint 1.0 of the open interval (1.0; 2.0), and the value of each bit of the mantissa part of the bit sequence L has the logical value 0. By adding the bit sequence L to the logical product P, the adder circuit 313 replaces the sign and the exponent part of the logical product P with the sign and the exponent part of the bit sequence L.

The bit sequence L is an example of a fourth bit sequence, and the sign and the exponent part of the bit sequence L are an example of a bit sequence of a predetermined sign bit and a predetermined exponent part. The pseudo random number R is an example of the second bit sequence, and the adder circuit 313 is an example of an adder circuit or unit.

In the case of the single-precision floating-point number, the bit sequence L can be expressed by the following formula (5).

L=0x3f800000=0011 1111 1000 0000 0000 0000 0000 0000 (5)

In the formula (5), “0x” represents a hexadecimal number. In the case where the logical product P is expressed by the formula (4) described above, the pseudo random number R can be obtained using the following formula (6).

R=P+L=0011 1111 1111 0000 1110 1110 0000 0000 (6)

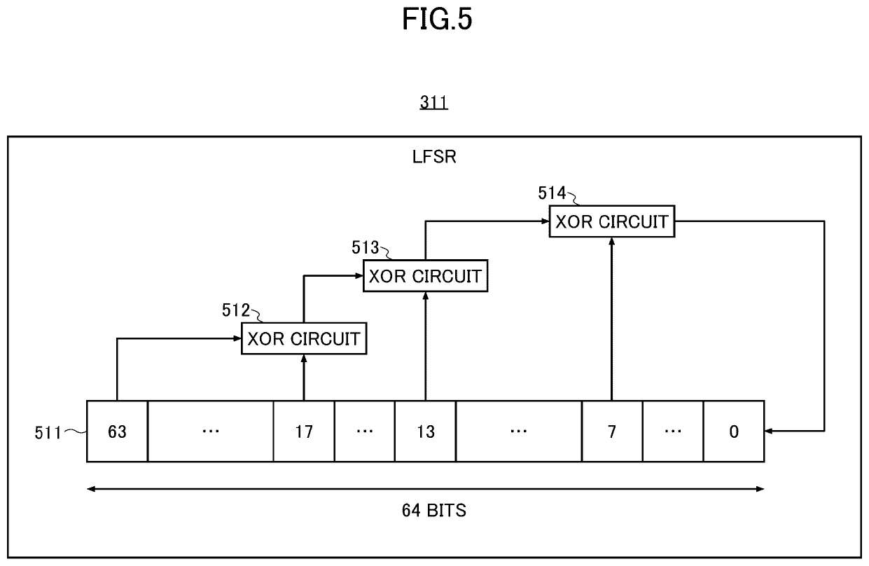

FIG. 5 illustrates an example of a hardware configuration of the second LFSR 311. The LFSR 311 illustrated in FIG. 5 includes a shift register 511, an XOR circuit 512, an XOR circuit 513, and an XOR circuit 514. The shift register 511, the XOR circuit 512, the XOR circuit 513, and the XOR circuit 514 are hardware circuits or components.

The shift register 511 stores a bit sequence having a bit length with double-precision floating-point representation prescribed by the IEEE 754 standard. The bit length with the double-precision floating-point representation is 64 bits. Among bit 0 to bit 63, bit 0 to bit 51 represent the mantissa part, bit 52 to bit 62 represent the exponent part, and bit 63 represents the sign.

The XOR circuit 512 outputs an exclusive OR of a bit value of the bit 17 and a bit value of the bit 63 of the shift register 511 to the XOR circuit 513. The XOR circuit 513 outputs an exclusive OR of a bit value of the bit 13 of the shift register 511 and the output from the XOR circuit 512 to the XOR circuit 514.

The XOR circuit 514 outputs an exclusive OR of a bit value of the bit 7 of the shift register 511 and the output from the XOR circuit 513 to the bit 0 of the shift register 511. Accordingly, a bit value of a bit i (i=0 to 62) before the update is shifted to the bit i+1, and the bit 0 to the bit 63 after the shift are output as the bit sequence z.

The Xorshift by the LFSR 311 illustrated in FIG. 5 can be described by the following formula (7), for example.

Z=z\hat{ }z_13\hat{ }z_7\hat{ }z_17 (7)

In the formula (7), “z_i” represents the bit value of the bit i of shift register 511. In the case of the double-precision floating point number, the mask bit sequence M and the bit sequence L can be expressed by the following formulas (8) and (9), respectively.

M=0000 0000 0000 1111 1111 1111 1111 1111 1111 1111 1111 1111 1111 1111 1111 1111 (8)

L=0x3ff0000000000000=0011 1111 1111 0000 0000 0000 0000 0000 0000 0000 0000 0000 0000 0000 0000 0000 (9)

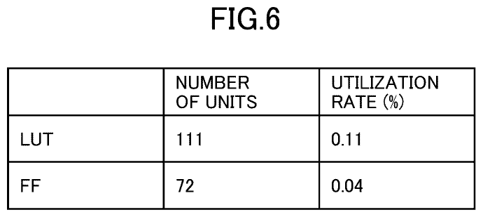

FIG. 6 illustrates an example of a hardware quantity for a case where the LFSR 311 illustrated in FIG. 4 is implemented by a field programmable gate array (FPGA). A number of lookup tables (LUTs) used is 111, and a utilization rate thereof is 0.11%. A number of flip-flops (FFs) used is 72, and a utilization rate thereof is 0.04%. An operation clock cycle is 2.006 ns, and a clock frequency is 498.5 MHz. In this case, the LFSR 311 is implemented by a very small hardware quantity.

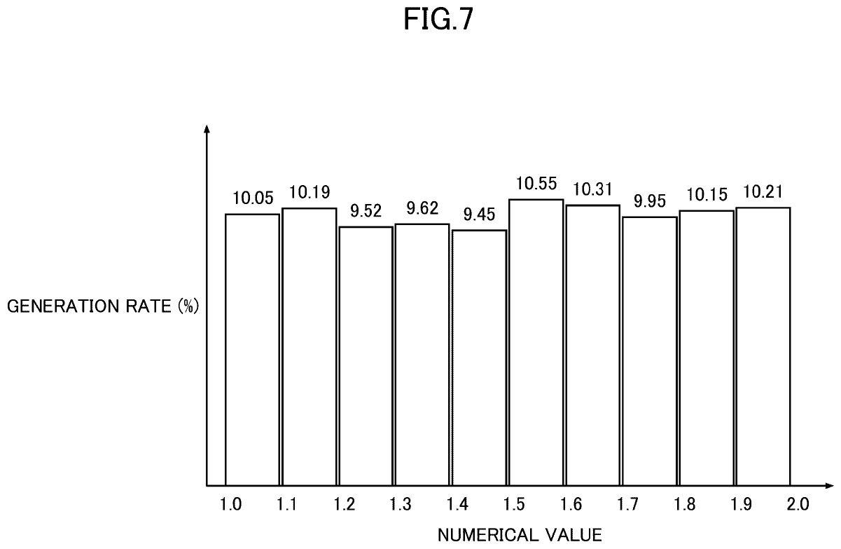

FIG. 7 illustrates an example of a distribution of pseudo random numbers generated using the hardware illustrated in FIG. 6. In this example, one pseudo random number is generated for every 2.006 ns, and a total of 10,000 pseudo random numbers are generated. The abscissa represents a numerical value of the generated pseudo random number, and the ordinate represents a generation rate (%) of the numerical value included in each numerical value range. The open interval (1.0; 2.0) is divided into ten numerical value ranges having a width of 0.1.

The generated pseudo random numbers are distributed substantially uniformly over the ten numerical value ranges, and it may be regarded that the random numbers can be generated with a sufficient randomness.

According to the pseudo random number generator 301 illustrated in FIG. 3, it is possible to efficiently generate the pseudo random numbers with the floating-point representation in the open interval (1.0; 2.0), using a small hardware quantity. Hence, in a parallel computing system using the reconfigurable architecture, such as the CGRA, the systolic array, or the like, the pseudo random number generator 301 can be easily implemented for each row or column of the reconfigurable matrix.

The range of the generated pseudo random numbers is not limited to the open interval (1.0; 2.0), and may be specified by the user or the external device. As an example, a pseudo random number generator that generates pseudo random numbers with the floating-point representation in a specified open interval (a; b) will be described, where “a” and “b” are real numbers, and a<b.

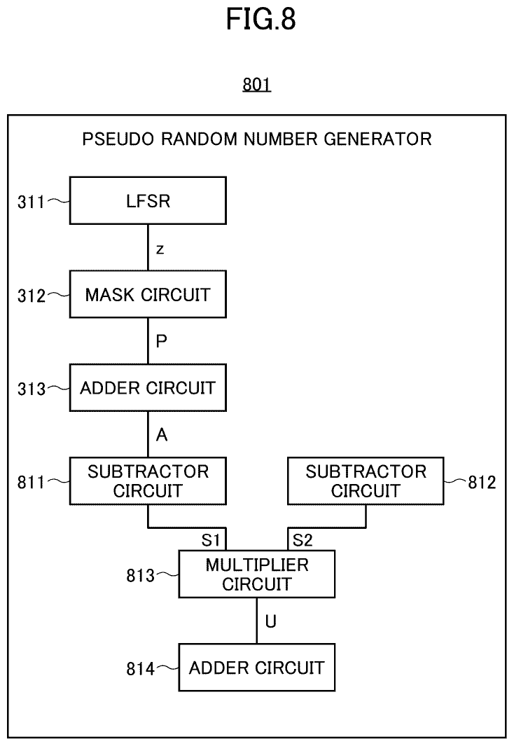

FIG. 8 illustrates an example of a hardware configuration of a second pseudo random number generator. A pseudo random number generator 801 illustrated in FIG. 8 corresponds to the pseudo random number generator 101 illustrated in FIG. 1, and has a configuration in which a subtractor circuit 811, a subtractor circuit 812, a multiplier circuit 813, and an adder circuit 814 are added to the pseudo random number generator 301 illustrated in FIG. 3. The subtractor circuit 811, the subtractor circuit 812, the multiplier circuit 813, and the adder circuit 814 are hardware circuits or components.

The adder circuit 313 outputs an addition result A of the logical product P and the bit sequence L to the subtractor circuit 811. The subtractor circuit 811, the subtractor circuit 812, the multiplier circuit 813, and the adder circuit 814 convert the pseudo random number in the open interval (1.0; 2.0) into the pseudo random number R in the open interval (a; b), by performing a floating-point arithmetic operation described by the following formula (10).

R=a+(A−1.0)×((b−a)/(2.0−1.0))=a+(A−1.0)×(b−a) (10)

The subtractor circuit 811 subtracts 1.0 from the addition result A with the floating-point representation, and outputs a subtraction result S1 to the multiplier circuit 813. The subtractor circuit 812 subtracts “a” from “b” in the floating-point representation, and outputs a subtraction result S2 to the multiplier circuit 813. The addition result A is an example of a fifth bit sequence.

The multiplier circuit 813 multiplies the subtraction result S1 by the subtraction result S2 with the floating-point representation, and outputs a multiplication result U to the adder circuit 814. The adder circuit 814 adds “a” to the multiplication result U with the floating-point representation, and outputs an addition result as the pseudo random number R. The pseudo random number R is an example of the second bit sequence, and the subtractor circuit 811, the subtractor circuit 812, the multiplier circuit 813, and the adder circuit 814 are examples of an arithmetic circuit or unit.

According to the pseudo random number generator 801 illustrated in FIG. 8, it is possible to efficiently generate the pseudo random numbers with the floating-point representation in the specified open interval (a; b), using a small hardware quantity.

It is also possible to generate the pseudo random numbers using an information processing apparatus (or computer), in place of the pseudo random number generator 301 illustrated in FIG. 3 and the pseudo random number generator 801 illustrated in FIG. 8.

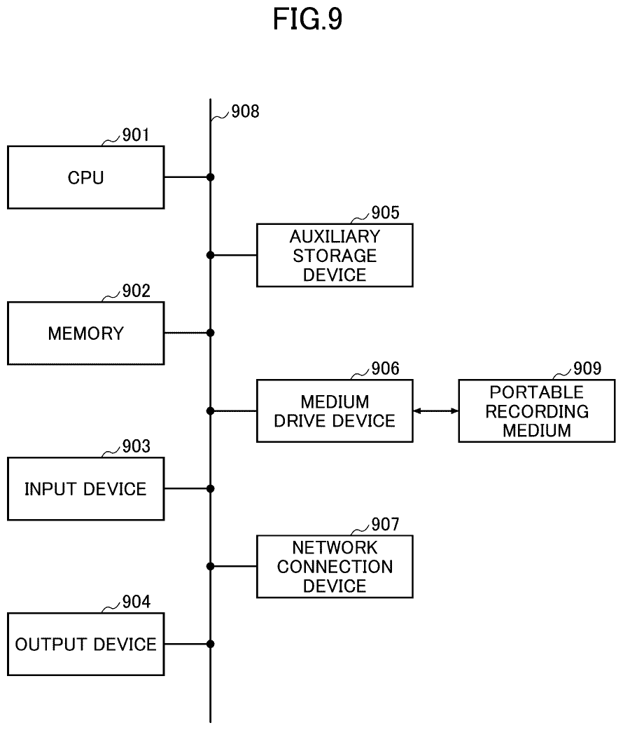

FIG. 9 illustrates an example of a hardware configuration of the information processing apparatus that operates as a pseudo random number generator. The information processing apparatus illustrated in FIG. 9 includes a central processing unit (CPU) 901, a memory 902, an input device 903, an output device 904, an auxiliary storage device 905, a medium drive device 906, and a network connection device 907. These constituent elements or components of the information processing apparatus are hardware circuits or components that are connected to one another via a bus 908.

The memory 902 is a semiconductor memory, such as a read only memory (ROM), a random access memory (RAM), or the like, for example, and stores one or more programs and data used for performing processes. The memory 902 may store the bit sequence within the shift register 411 illustrated in FIG. 4 or the shift register 511 illustrated in FIG. 5, as the data.

The CPU (or processor) 901 performs the same processes as the operations of the LFSR 311, the mask circuit 312, and the adder circuit 313 illustrated in FIG. 3 and FIG. 8 by executing one or more programs using the memory 902, for example. The CPU 901 also performs the same processes as the operations of the subtractor circuit 811, the subtractor circuit 812, the multiplier circuit 813, and the adder circuit 814 illustrated in FIG. 8 by executing one or more programs using the memory 902.

The CPU 901 also performs the same processes as the operations of the shift register 411, the XOR circuit 412, the XOR circuit 413, and the XOR circuit 414 illustrated in FIG. 4 by executing one or more programs using the memory 902. The CPU 901 also performs the same processes as the operations of the shift register 511, the XOR circuit 512, the XOR circuit 513, and the XOR circuit 514 illustrated in FIG. 5 by executing one or more programs using the memory 902.

The input device 903 is a keyboard, a pointing device, or the like, for example, and is used for inputting an instruction or information from the user or an operator. The output device 904 is a display device, a printer, a speaker, or the like, for example, and is used for outputting an inquiry or a processed result to the user or the operator. The processed result may be a pseudo random number R.

The auxiliary storage device 905 is a magnetic disk device (or drive), an optical disk device (or drive), a magneto-optical disk device (or drive), a tape device (or drive), or the like, for example. The auxiliary storage device 905 may be a hard disk drive (HDD) or a solid state drive (SSD). The information processing apparatus can store one or more programs and data in advance in the auxiliary storage device 905, and load the one or more programs and the data into the memory 902 when using the one or more programs and the data.

The medium drive device 906 drives a portable recording medium 909, and makes access to recorded contents in the portable recording medium 909. The portable recording medium 909 is a memory device, a flexible disk, an optical disk, a magneto-optical disk, or the like. The portable recording medium 909 may be a compact disk read only memory (CD-ROM), a digital versatile disk (DVD), a universal serial bus (USB) memory, or the like. The user or the operator can store the one or more programs and the data in the portable recording medium 909, and can use the one or more programs and the data by loading the one or more programs and the data into the memory 902.

As described above, a computer-readable storage medium that stores the one or more programs and the data to be used for the processes is a physical, non-transitory computer-readable storage medium, such as the memory 902, the auxiliary storage device 905, the portable recording medium 909, or the like.

The network connection device 907 is a communication device that is connected to a communication network, such as a wide area network (WAN), a local area network (LAN), or the like, and performs a data conversion associated with the communication. The information processing apparatus can receive the one or more programs and the data from the external device via the network connection device 907, and can load the one or more programs and the data into the memory 902 when using the one or more programs and the data.

The configurations of the pseudo random number generator 101 illustrated in FIG. 1, the pseudo random number generator 301 illustrated in FIG. 3, and the pseudo random number generator 801 illustrated in FIG. 8 are merely examples, and some of the constituent elements or components may be omitted or modified according to the purpose or conditions of the pseudo random number generator. For example, the bit sequence z may be generated using another pseudo random number generation circuit in place of the LFSR 311 illustrated in FIG. 3 or FIG. 8.

The configurations of the LFSR 311 illustrated in FIG. 4 and the LFSR 311 illustrated in FIG. 5 are merely examples, and some of the constituent elements or components may be omitted or modified according to the purpose or conditions of the pseudo random number generator. For example, in the LFSR 311 illustrated in FIG. 4, the bit values of other bits of the shift register 411 may be input to the XOR circuit 412, the XOR circuit 413, and the XOR circuit 414, respectively. In addition, in the LFSR 311 illustrated in FIG. 5, the bit values of other bits of the shift register 511 may be input to the XOR circuit 512, the XOR circuit 513, and the XOR circuit 514, respectively.

The flow chart illustrated in FIG. 2 is merely an example, and some of the steps or processes may be omitted or modified according to the purpose or conditions of the pseudo random number generator.

The hardware quantity illustrated in FIG. 6 and the distribution of the pseudo random numbers illustrated in FIG. 7 are merely examples, and the hardware quantity of the pseudo random number generator and the distribution of the generated pseudo random numbers may vary depending on the method of implementing the pseudo random number generator.

The configuration of the information processing apparatus illustrated in FIG. 9 is merely an example, and some of the constituent elements or components may be omitted or modified according to the purpose or conditions of the information processing apparatus. For example, in a case where an interface with the user or the operator is unnecessary, the input device 903 and the output device 904 may be omitted. In a case where the portable recording medium 909 or the communication network is not used, the medium drive device 906 or the network connection device 907 may be omitted.

The formulas (1) to (10) are merely examples, and the pseudo random number generator may generate the pseudo random number R based on other formulas.

Although the disclosed embodiments and advantageous features thereof are described above in detail, those skilled in the art will appreciate that various variations, modifications, additions, substitutions, and omissions may be made without departing from the scope of the present disclosure.

According to an aspect of the present disclosure, it is possible to efficiently generate pseudo random numbers with floating-point representation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A pseudo random number generator comprising:
a first generator configured to generate a random first bit sequence having a bit length with floating-point representation; and
a second generator configured to generate a second bit sequence having the bit length, using a predetermined sign bit, a bit sequence of a predetermined exponent part, and a bit sequence of a mantissa part included in the first bit sequence.

2. The pseudo random number generator as claimed in claim 1, wherein the second generator includes:
a modification circuit configured to generate a third bit sequence having the bit length from the first bit sequence, by modifying values of a sign bit and each bit of a bit sequence of an exponent part to a logical value 0; and
an adder circuit configured to generate the second bit sequence by adding a fourth bit sequence including the predetermined sign bit, the bit sequence of the predetermined exponent part, and the bit sequence of the predetermined mantissa part to the third bit sequence, and
a value of each bit included in the bit sequence of the predetermined mantissa part is a logical value 0.

3. The pseudo random number generator as claimed in claim 1, wherein the first generator is a linear feedback shift register.

4. The pseudo random number generator as claimed in claim 1, wherein the second generator includes:
a modification circuit configured to generate a third bit sequence having the bit length from the first bit sequence, by modifying values of a sign bit included in the first bit sequence and each bit of a bit sequence of an exponent part to a logical value 0;
an adder configured to generate a fifth bit sequence having the bit length by adding a fourth bit sequence including the predetermined sign bit, the bit sequence of the predetermined exponent part, and the bit sequence of the predetermined mantissa part to the third bit sequence; and
an arithmetic circuit configured to generate the second bit sequence by performing a floating-point arithmetic operation using the fifth bit sequence, and
a value of each bit included in the bit sequence of the predetermined mantissa part is a logical value 0.

5. The pseudo random number generator as claimed in claim 4, wherein the first generator is a linear feedback shift register.

6. A non-transitory computer-readable storage medium having stored therein a pseudo random number generation program which, when executed by a computer, causes the computer to perform a process including:
generating a random first bit sequence having a bit length with floating-point representation; and
generating a second bit sequence having the bit length, using a predetermined sign bit, a bit sequence of a predetermined exponent part, and a bit sequence of a mantissa part included in the first bit sequence.

7. The non-transitory computer-readable storage medium as claimed in claim 6, wherein the process of generating the second bit sequence includes:
generating a third bit sequence having the bit length from the first bit sequence, by modifying values of a sign bit and each bit of a bit sequence of an exponent part to a logical value 0; and
generating the second bit sequence by adding a fourth bit sequence including the predetermined sign bit, the bit sequence of the predetermined exponent part, and the bit sequence of the predetermined mantissa part to the third bit sequence, and
a value of each bit included in the bit sequence of the predetermined mantissa part is a logical value 0.

8. The non-transitory computer-readable storage medium as claimed in claim 6, wherein the process of generating the second bit sequence includes:
generating a third bit sequence having the bit length from the first bit sequence, by modifying values of a sign bit included in the first bit sequence and each bit of a bit sequence of an exponent part to a logical value 0;
generating a fifth bit sequence having the bit length by adding a fourth bit sequence including the predetermined sign bit, the bit sequence of the predetermined exponent part, and the bit sequence of the predetermined mantissa part to the third bit sequence; and
generating the second bit sequence by performing a floating-point arithmetic operation using the fifth bit sequence, and
a value of each bit included in the bit sequence of the predetermined mantissa part is a logical value 0.

9. A pseudo random number generation method to be implemented in a computer, causing the computer to perform a process including:
generating a random first bit sequence having a bit length with floating-point representation; and
generating a second bit sequence having the bit length, using a predetermined sign bit, a bit sequence of a predetermined exponent part, and a bit sequence of a mantissa part included in the first bit sequence.

10. The pseudo random number generation method as claimed in claim 9, wherein the computer is caused to perform the process of generating the second bit sequence including:
generating a third bit sequence having the bit length from the first bit sequence, by modifying values of a sign bit and each bit of a bit sequence of an exponent part to a logical value 0; and
generating the second bit sequence by adding a fourth bit sequence including the predetermined sign bit, the bit sequence of the predetermined exponent part, and the bit sequence of the predetermined mantissa part to the third bit sequence, and
a value of each bit included in the bit sequence of the predetermined mantissa part is a logical value 0.

11. The pseudo random number generation method as claimed in claim 9, wherein the computer is caused to perform the process of generating the second bit sequence including:
generating a third bit sequence having the bit length from the first bit sequence, by modifying values of a sign bit included in the first bit sequence and each bit of a bit sequence of an exponent part to a logical value 0;
generating a fifth bit sequence having the bit length by adding a fourth bit sequence including the predetermined sign bit, the bit sequence of the predetermined exponent part, and the bit sequence of the predetermined mantissa part to the third bit sequence; and
generating the second bit sequence by performing a floating-point arithmetic operation using the fifth bit sequence, and
a value of each bit included in the bit sequence of the predetermined mantissa part is a logical value 0.
